(19) United States
(12) Patent Application Publication
(10) Pub. No.: US 2007/0067900 A1
(43) Pub. Date: Mar. 29, 2007

(54) Jet for hydromassage baths

(76) Inventor: Alessandro Moretto, Castions De Zoppola (IT)

Correspondence Address: AMERICAN STANDARD INC., ONE CENTENNIAL AVENUE, PISCATAWAY, NJ, 08855-6820, US

(21) Appl. No.: 11/589,479

(22) Filed: Oct. 30, 2006

(30) Foreign Application Priority Data
May 19, 2004 (IT) RE2004AO00055

(51) Int. Cl. A61H 33/04

(52) U.S. Cl. 4/541.6

(57) ABSTRACT

A jet (1) for hydromassage baths comprising: a collector group (2) suitable for being fixed to a wall of the basin of the bath; a water supply duct (3)communicating with said collector group (2); at least one air supply duct (4) communicating with said collector group (2); a flow conveyor (12) provided with an opening (13) suitable for conveying the water coming from the water supply duct (3) towards an ejection hole (11) ; a shutter (16) mobile between an open position and a closed position, to open and close the ejection hole (11), respectively, said open position being obtained and maintained by means of the hydraulic action generated by the pressure of the water against the action of elastic means (15), said elastic means (15) taking the shutter (16) back into the closed position when said flow of water is not present, the air coming from the air supply duct (4) mixing with the water in a mixing chamber (23) before being ejected through the ejection hole (11).

The present invention refers to a jet for hydromassage baths in accordance with the preamble of claim 1.

More specifically, the present invention refers to a jet for injecting a mixture of air and water into the basin of a hydromassage bath.

As known, hydromassage baths comprise a basin equipped, on the walls, with jets fed by a pump unit that takes water from the basin itself, filled previously, and sends it back, under pressure, into the basin through suitably shaped nozzles; pressurised water or a mixture of water and air can be sent.

Since the bath, even if equipped with a hydromassage unit, is usually also used to clean the body, it is important that the jets do not allow water to leak both towards the jets themselves and towards the pipes of said unit when the hydromassage unit is inactive.

This is in order to avoid water stagnation, which together with possible hairs, grease and dirty water, could create mould and bad smells, as well as create problems of blocking of the devices inside the jet, for example preventing correct mixing of air and water.

Currently, to avoid the drawbacks of the prior art described above, jets are used that are constructively complex as well as expensive.

Therefore, there is a great need for a jet for hydromassage baths that is simple to manufacture and assemble and that is manufactured with low costs.

The purpose of the present invention is that of providing a jet for hydromassage baths having structural and functional characteristics such as to satisfy the aforementioned requirements and at the same time to avoid the aforementioned drawbacks with reference to the prior art, with a simple and rational solution.

Such a purpose is accomplished through a jet for hydromassage baths in accordance with claim 1.

The dependent claims outline preferred and particularly advantageous embodiments of the jet for hydromassage baths according to the invention.

Further characteristics and advantages of the invention shall become clear from reading the following description provided as an example and not for limiting purposes, with the help of the figures illustrated in the attached tables, in which:

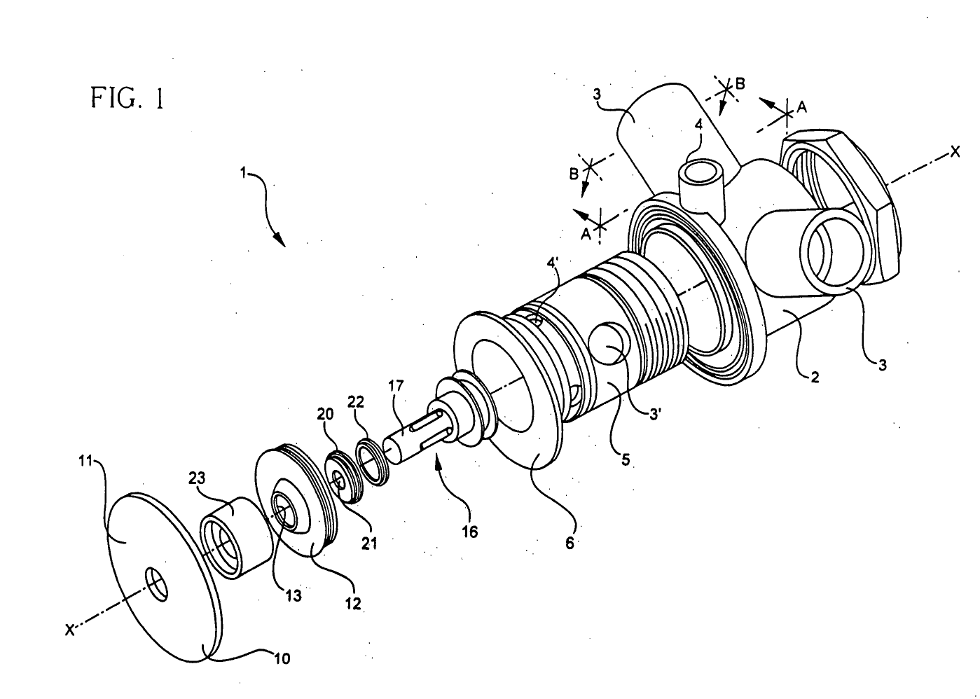

FIG. 1 shows an exploded perspective view of a jet in accordance with the present invention;

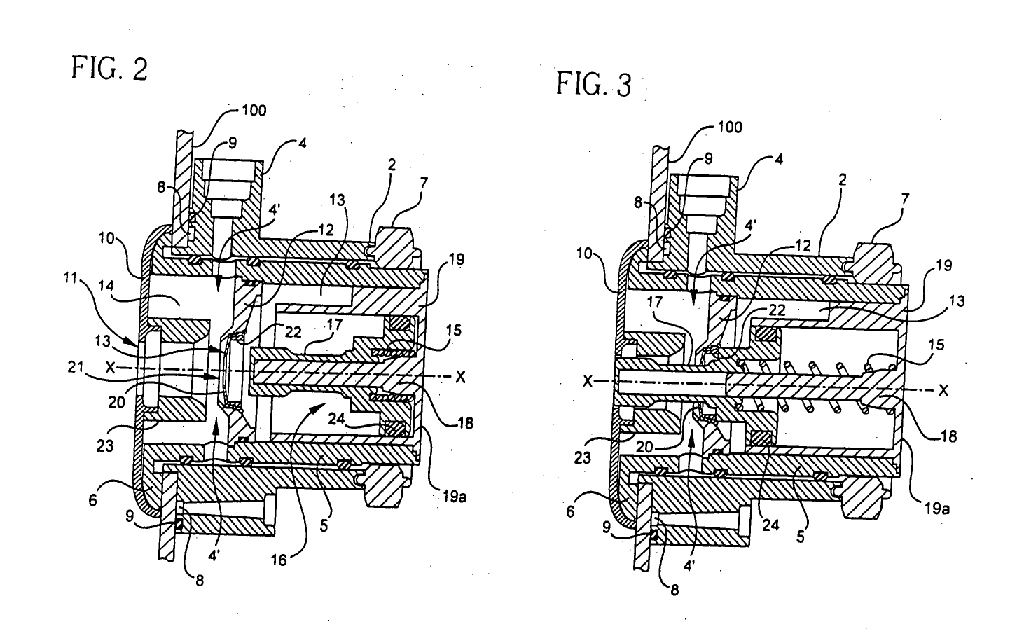

FIGS. 2 and 3 show a section view taken along the plane A-A of FIG. 1, in open and closed position, respectively;

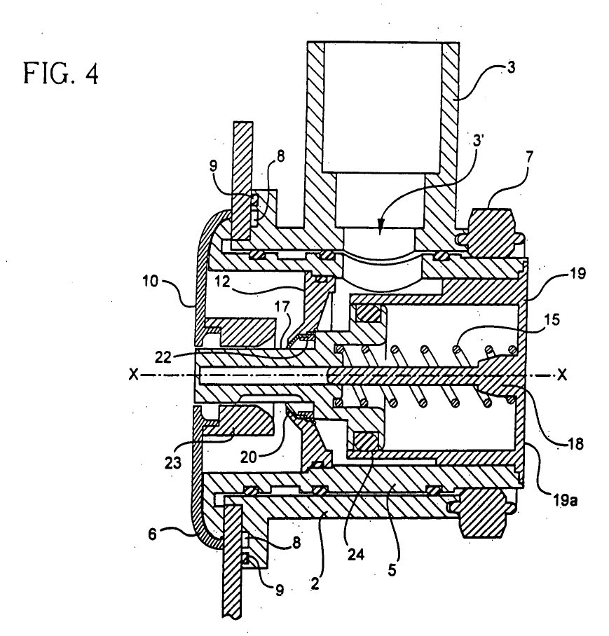

FIG. 4 shows a section view taken along the plane B-B of FIG. 1, in closed position.

With reference to the aforementioned figures, a jet for hydromassage baths in accordance with the present invention is globally indicated with 1.

The jet 1 comprises a collector group 2 suitable for being fixed to a wall 100 of the basin of the bath at an entry hole for water into the basin.

At least one water supply duct 3, in the example two in number, and at least one air supply duct 4, in the example one in number, are associated in fluid communication with the collector group 2, also called simply collector.

The collector 2 has a hollow circular cylindrical configuration defining a recess having a central axis X-X with the two water ducts 3 arranged symmetrically at the plane containing the axis X-X and the air duct 4 arranged as can be seen in FIG. 1, where the corresponding fittings manufactured in a single piece with the collector itself are represented for the sake of simplicity.

A short pipe 5 having a hollow cylindrical configuration of a size such as to brush the entire inner surface of the collector 2 is inserted inside the recess of the collector 2.

The short pipe 5 is provided with openings 3′, 4′ at the supply ducts 3, 4 and at one of its ends with an annular rim 6 projecting radially. At the opposite end a locking bush 7 is screwed onto a threading formed on a distal portion with respect to the basin of the bath.

The annular rim 6 abuts against the basin of the bath where it is sealed against water leakage from the basin itself through Silicon injected in an annular seat 8 formed on the collector portion 2 abutting against the basin of the tank.

In addition, it is foreseen to use an annular gasket 9 that is also housed in an annular seat outside of and concentric to the annular seat filled with silicon.

A circular cover 10, provided centrally with an ejection hole 11, is associated onto the annular rim 6, with means of the prior art.

A flow conveyor 12 provided with an opening 12a for conveying the water coming from the water supply ducts 3 towards the ejection hole 11 is inserted into the short pipe 5.

The conveyor 12 divides the collector 2, and therefore the short pipe 5 inserted in it, into two chambers: a first chamber 13 (on the right in the figures) in which the water coming from the water supply ducts 3 arrives and a second chamber 14 (on the left in the figures) in which the air coming from the air supply duct 4 arrives.

In order to be able to interrupt the fluid communication between the ejection hole 11 and the supply ducts 3, 4 it is foreseen to use a shutter mobile between an open position and a closed position, to open and close the ejection hole 11, respectively.

The open position is obtained and maintained by means of the hydraulic action generated by the pressure of the water coming from the supply ducts 3, 4 against the action of elastic means, in the example a coiled return spring 15.

The closed position is caused by said spring 15 that takes the shutter back into the closed position, when there is no water flow.

The shutter takes the form of a piston 16 with a cylindrical stem 17, this stem being suitably shaped to perfectly close the ejection hole 11 when it is in closed position.

The stem 17 of the piston 16 is hollow and is slidably slotted onto a piston guide pin 18 at the base of which a spring 15 is arranged that acts to return the piston 16.

In order to allow the piston 16 to move correctly along the axis X-X, a jacket 19, open only at the end facing towards the ejection hole 11, is associated with the end of the short pipe 5 opposite that where the annular rim 6 is present.

At the base of the piston an annular seat is formed in which a gasket 24 is inserted suitable for forming a seal with the jacket 19.

The jacket 19 has a base 19a suitable for preventing the leaking of pressurised water coming from the water supply ducts 3 and is manufactured in a single piece with the piston guide pin 18 arranged internally and centrally along the axis X-X.

In practice, the jacket 19 occupies most of the first chamber 13 since it extends up to close to the conveyor 12 without, however, brushing it and has a smaller cross section than that of the short pipe 5 at least at the entry of the supply water, as can be seen in the figures.

A nozzle 20 made from viscoelastic material, in the example silicon rubber, provided with a through hole 21 is associated with said flow conveyor 12 at the opening 12a.

The nozzle 20 is associated with the conveyor 12 through a fastening ring 22 shaped to be force-fitted onto the conveyor 12 according to the prior art of the field.

The through hole 21 covers a smaller surface than that of the opening of the conveyor 12 and than the cross section of the stem 17.

In the second chamber 14 in which the air arrives a hollow cylinder 23 is housed arranged coaxially to the short pipe 5 at the ejection hole 11 of the cover 10.

In the example, the cylinder 23 is associated with the cover 10 and has a through port of a size equal to that of the ejection hole 11.

Functionally, starting from the closed condition of FIG. 3, the water arriving from the water supply ducts 3 enters into the jacket 19 and pushes the piston 16 towards the base of the jacket 19a. The piston 16, going down, frees firstly the ejection hole 11 and then the through hole 21 of the nozzle 20 allowing the pressurised water coming from the water supply duct 3 to reach the ejection hole 11.

Due to the high speed with which the water crosses the through holes 21 of the nozzle 20 and with which it reaches the cylinder 23 housed in the second chamber 14, the air coming from the air supply duct 4 in communication with the second chamber 14 is sucked by Venturi effect into the cylinder 23 itself where a mixing of air and water takes place before going out from the ejection hole 11.

At the end of the water delivery, the thrust exerted by the spring 15 is no longer counteracted by the hydraulic force of the water and takes the stem 17 of the piston 16 back into closed position, illustrated in FIG. 3.

Since the size of the through hole 21 through which the stem 17 passes is smaller than the cross section of the stem itself, there shall be slight friction between the nozzle 20 made from silicon rubber and the stem 17, therefore the stem 17 shall reversibly deform the nozzle 20.

Basically, when the shutter 16, is in closed position, the special configuration and the type of material of the nozzle 20 contribute further (in addition to the spring) to preventing water leaking towards the jet 1.

As can be appreciated from that which has been described, the jet 1 for hydromassage baths according to the present invention allows the requirements to be satisfied and allows the drawbacks mentioned in the introductive part of the present description with reference to the prior art to be overcome.

Indeed, the jet of the present invention prevents the water present in the bath from leaking inside the jet even when the hydromassage unit is inactive.

Moreover, said jet is simple to assemble making the subsequent disassembly for cleaning quick and easy to carry out.

Of course, a man skilled in the art can bring numerous modifications to the jet for hydromassage baths described above in order to satisfy contingent and specific requirements, all of these modifications in any case being covered by the scope of protection of the invention, as defined by the following claims.

1. Jet (1) for hydromassage baths comprising:
a collector group (2) suitable for being fixed to a wall of the basin of the bath at an entry hole for water into the basin;
at least one water supply duct (3) communicating with said collector group (2);
at least one air supply duct (4) communicating with said collector group (2);
characterised in that it comprises:
a flow conveyor (12) provided with an opening (12a) suitable for conveying the water coming from water supply duct (3) towards an ejection hole (11);
a shutter (16) mobile between an open position and a closed position, to open and close the ejection hole (11), respectively, said open position being obtained and maintained by means of the hydraulic action generated by the pressure of the water coming from the water supply duct (3) against the action of elastic means (15), said elastic means (15) taking the shutter (16) back into the closed position, when said flow of water is not present, the air coming from the air supply duct (4) mixing with the water in a mixing chamber (23) before being ejected through the ejection hole (11).

2. Jet (1) according to claim 1, wherein said mixing chamber (23) is arranged downstream of the flow conveyor (12).

3. Jet (1) according to claim 1, wherein a hollow cylinder (23) is placed between said flow conveyor (12) and said ejection hole (11).

4. Jet (1) according to claim 3, wherein said mixing chamber is defined by said hollow cylinder (23)

5. Jet (1) according to claim 1, wherein said collector group (2) has a through recess defining two chambers (13, 14) with said conveyor (12) placed between them, a first chamber (13) in which the water coming from the water supply duct (3) arrives and a second chamber (14) in which the air coming from said air supply duct (4) arrives.

6. Jet (1) according to claim 5, further comprising a short pipe (5) shaped to be inserted into the collector group (2) and having an annular rim (6) projecting radially, suitable for abutting against said wall of the basin of the bath.

7. Jet (1) according to claim 6, comprising a cover (10) provided with said ejection hole (11) that can be associated with said annular rim (6).

8. Jet (1) according to claim 1, wherein a nozzle (20) made from viscoelastic material is associated with said flow conveyor (12) at the opening (13).

9. Jet (1) according to claim 8, wherein said nozzle (20) is associated with said conveyor (12) through a fastening ring (22) shaped to be force-fitted onto said conveyor (12).

10. Jet (1) according to claim 8, wherein said nozzle (20) has a through hole (21) having a smaller section than that of the shutter (16).

11. Jet (1) according to claim 10, wherein said mobile shutter (16) slides inside said through hole (21) reversibly deforming said nozzle (20).

12. Jet (1) according to claim 1, wherein said shutter (16) has a base that can slide inside a guide jacket (19) for the shutter (16).
